(19) United States
(12) Patent Application Publication
(10) Pub. No.: US 2013/0024469 A1
(43) Pub. Date: Jan. 24, 2013

(54) APPARATUS AND METHOD FOR PREVENTING REGRESSION DEFECTS WHEN UPDATING SOFTWARE COMPONENTS

(71) Applicants: Xiao Chuan Cai, Shanghai (CN); Yi Qian, Beijing (CN); Nedzad Taljanovic, Tucson, AZ (US); Yuan Wang, Shanghai (CN)

(72) Inventors: Xiao Chuan Cai, Shanghai (CN); Yi Qian, Beijing (CN); Nedzad Taljanovic, Tucson, AZ (US); Yuan Wang, Shanghai (CN)

(73) Assignee: INTERNATIONAL BUSINESS MACHINES CORPORATION, Armonk, NY (US)

(21) Appl. No.: 13/188,379

(22) Filed: Jul. 21, 2011

(51) Int. Cl. G06F 17/30

(52) U.S. Cl. 707/769; 707/E17.014

(57) ABSTRACT

A method for preventing regression defects when updating software components is disclosed. In one embodiment, such a method includes providing a source repository storing multiple software components (e.g., software modules, source files, sections of program code, etc.). The method determines associations between the software components and stores these associations in a database. The method further enables a user to check out a software component from the source repository in order to make updates, and check in the software component to the source repository once updates are made. At a designated time, such as when the software component is checked in or out, the method automatically checks the database to determine whether the software component has an association with any other software component in the source repository. The method notifies the user if an association is discovered. A corresponding computer program product and apparatus are also disclosed.

### BACKGROUND

1. Field of the Invention

This invention relates to apparatus and methods for tracking and controlling changes in software, and more specifically to apparatus and methods for preventing regression defects in software.

2. Background of the Invention

In large software projects, different sections of code typically interact to accomplish a goal. Often, code that is logically related is split across multiple files. For example, a registration page for a web application may have display code in a JavaServer Page (JSP) file, client-side validation in a JavaScript file, and server-side processing in a Java file. The code in these files interacts to accomplish the registration operation. Typically a change in one file will require changes in the other related files.

However, whenever software is updated, particularly in large software projects, there is the possibility of introducing “regression defects” into the code. Regression defects are defects that are introduced into code when fixing, enhancing, or making other changes to the code. Such defects are more likely to occur when the developer who is updating the code is not the original developer.

For example, suppose that the registration page discussed above requires a user to enter his or her birth date. Suppose that an update of the page is needed to support European locales, and thus different date formats (dd/mm/yyyy vs. mm/dd/yyyy). To address this need, a developer updates the client-side JavaScript file to validate the different format. After the updates are made, the application is tested with the date 10/7/2000 and the application appears to operate correctly. This change, however, introduced a regression defect into the code. The developer failed to make an update to the server-side Java file that parses the data. In this example, the test data just happened to work, causing the defect to go undetected.

Currently, various different techniques may be used to catch such defects. One technique is to conduct a plain text search of the software files for key words or phrases. For example, if the developer is working on a function called “display,” the developer may search the text of the software files for occurrences of the term “display.” Such a technique may return large amounts of irrelevant information (e.g., instances of the term “display” which have nothing to do with the function “display”) or miss information that is relevant (e.g., code may interact with the “display” function in some way without actually using the term “display”).

A second technique is to perform a syntax-sensitive search. Certain code editing software may recognize and highlight structures inside code such as functions or variable declarations. Upon selecting (e.g., right clicking) a desired structure, the editing software may provide references to the structure in other parts of the code. This type of search is more intelligent but may still miss relevant information. For example, if a first section of code writes to a location in memory, and a second section of code reads from the same location in memory, the two sections of code may be highly relevant to one another but may not contain syntax that links them together.

In view of the foregoing, what are needed are improved techniques for preventing regression defects when updating software components. Ideally, such techniques could discover relationships between software components even where conventional techniques such as plain-text searching and syntax-sensitive searching fail to detect such relationships.

### SUMMARY

The invention has been developed in response to the present state of the art and, in particular, in response to the problems and needs in the art that have not yet been fully solved by currently available apparatus and methods. Accordingly, the invention has been developed to provide apparatus and methods to prevent regression defects when updating software components. The features and advantages of the invention will become more fully apparent from the following description and appended claims, or may be learned by practice of the invention as set forth hereinafter.

Consistent with the foregoing, a method for preventing regression defects when updating software components is disclosed herein. In one embodiment, such a method includes providing a source repository storing multiple software components (e.g., software modules, source files, sections of program code, etc.). The method determines associations between the software components and stores these associations in a database. The method further enables a user to check out a software component from the source repository in order to make updates, and check in the software component to the source repository once updates are made. At a designated time, such as when the software component is checked in or out, the method automatically checks the database to determine whether the software component has an association with any other software component in the source repository. The method notifies the user if an association is discovered.

A corresponding computer program product and apparatus are also disclosed and claimed herein.

### BRIEF DESCRIPTION OF THE DRAWINGS

In order that the advantages of the invention will be readily understood, a more particular description of the invention briefly described above will be rendered by reference to specific embodiments illustrated in the appended drawings. Understanding that these drawings depict only typical embodiments of the invention and are not therefore to be considered limiting of its scope, the invention will be described and explained with additional specificity and detail through use of the accompanying drawings, in which:

FIG. 1 is a high-level block diagram showing one example of a computer system suitable for use with various embodiments of the invention;

FIG. 2 is a high-level block diagram showing one embodiment of a software configuration management (SCM) tool incorporating functionality in accordance with the invention;

FIG. 3 is a high-level block diagram showing one example of a table storing association records;

FIG. 4 is a flow diagram showing one embodiment of a method for preventing regression defects;

FIG. 5 is a flow diagram showing another embodiment of a method for preventing regression defects, the method taking into account weight values assigned to associations;

FIG. 6 is a flow diagram showing one embodiment of a method for determining associations and corresponding weight values for software components in a source repository;

FIG. 7 is a flow diagram showing a more particular example of a method for determining associations and corresponding weight values for software components in a source repository; and

FIGS. 8A through 8D show various approaches for notifying a user of the associations between software components.

### DETAILED DESCRIPTION

It will be readily understood that the components of the present invention, as generally described and illustrated in the Figures herein, could be arranged and designed in a wide variety of different configurations. Thus, the following more detailed description of the embodiments of the invention, as represented in the Figures, is not intended to limit the scope of the invention, as claimed, but is merely representative of certain examples of presently contemplated embodiments in accordance with the invention. The presently described embodiments will be best understood by reference to the drawings, wherein like parts are designated by like numerals throughout.

As will be appreciated by one skilled in the art, the present invention may be embodied as an apparatus, system, method, or computer program product. Furthermore, the present invention may take the form of a hardware embodiment, a software embodiment (including firmware, resident software, microcode, etc.) configured to operate hardware, or an embodiment combining software and hardware aspects that may all generally be referred to herein as a “module” or “system.” Furthermore, the present invention may take the form of a computer-usable storage medium embodied in any tangible medium of expression having computer-usable program code stored therein.

Any combination of one or more computer-usable or computer-readable storage medium(s) may be utilized to store the computer program product. The computer-usable or computer-readable storage medium may be, for example but not limited to, an electronic, magnetic, optical, electromagnetic, infrared, or semiconductor system, apparatus, or device. More specific examples (a non-exhaustive list) of the computer-readable storage medium may include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CDROM), an optical storage device, or a magnetic storage device. In the context of this document, a computer-usable or computer-readable storage medium may be any medium that can contain, store, or transport the program for use by or in connection with the instruction execution system, apparatus, or device.

Computer program code for carrying out operations of the present invention may be written in any combination of one or more programming languages, including an object-oriented programming language such as Java, Smalltalk, C++, or the like, and conventional procedural programming languages, such as the “C” programming language or similar programming languages. Computer program code for implementing the invention may also be written in a low-level programming language such as assembly language.

The present invention may be described below with reference to flowchart illustrations and/or block diagrams of methods, apparatus, systems, and computer program products according to various embodiments of the invention. It will be understood that each block of the flowchart illustrations and/or block diagrams, and combinations of blocks in the flowchart illustrations and/or block diagrams, can be implemented by computer program instructions or code. These computer program instructions may be provided to a processor of a general-purpose computer, special-purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable storage medium that can direct a computer or other programmable data processing apparatus to function in a particular manner, such that the instructions stored in the computer-readable storage medium produce an article of manufacture including instruction means which implement the function/act specified in the flowchart and/or block diagram block or blocks. The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

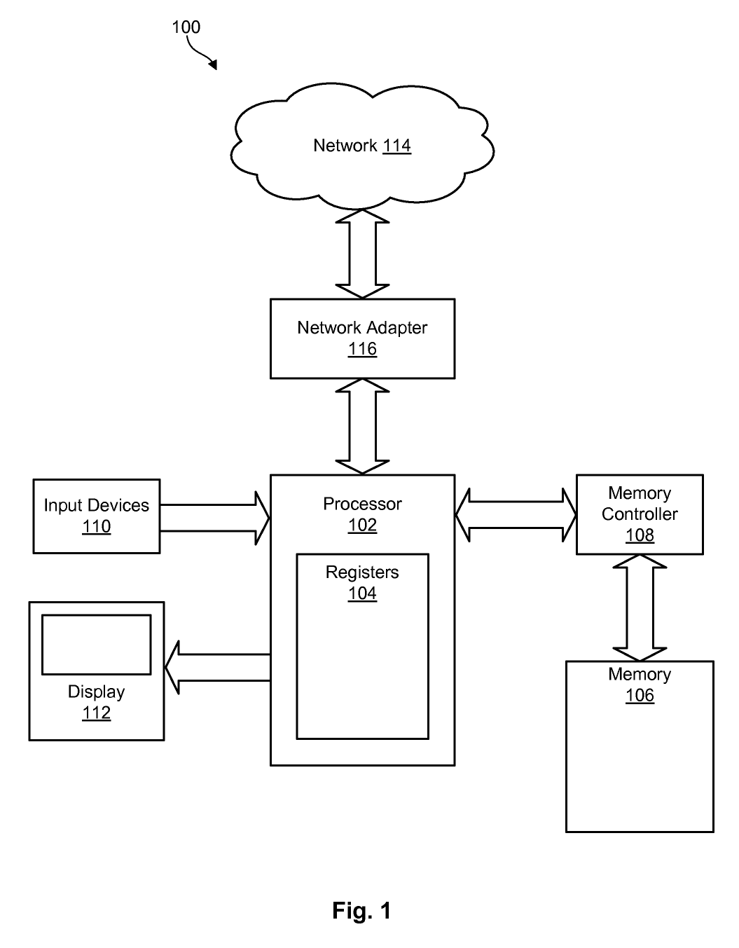

Referring to FIG. 1, one example of a computer system 100 is illustrated. The computer system 100 is presented to show one example of an environment where a method in accordance with the invention may be implemented. The computer system 100 is presented only by way of example and is not intended to be limiting. Indeed, the methods disclosed herein may be applicable to a wide variety of different computer systems in addition to the computer system 100 shown. The methods disclosed herein may also potentially be distributed across multiple computer systems 100.

The computer system 100 includes at least one processor 102 and may include more than one processor. The processor 102 includes one or more registers 104 storing data describing the state of the processor 102 and facilitating execution of software systems. The registers 104 may be internal to the processor 102 or may be stored in a memory 106. The memory 106 stores operational and executable data that is operated upon by the processor 102. The memory 106 may be accessed by the processor 102 by means of a memory controller 108. The memory 106 may include volatile memory (e.g., RAM) as well as non-volatile memory (e.g., ROM, EPROM, EEPROM, hard disks, flash memory, etc.).

The processor 102 may be coupled to additional devices supporting execution of software and interaction with users. For example, the processor 102 may be coupled to one or more input devices 110, such as a mouse, keyboard, touch screen, microphone, or the like. The processor 102 may also be coupled to one or more output devices such as a display device 112, speaker, or the like. The processor 102 may communicate with one or more other computer systems by means of a network 114, such as a LAN, WAN, or the Internet. Communication over the network 114 may be facilitated by a network adapter 116.

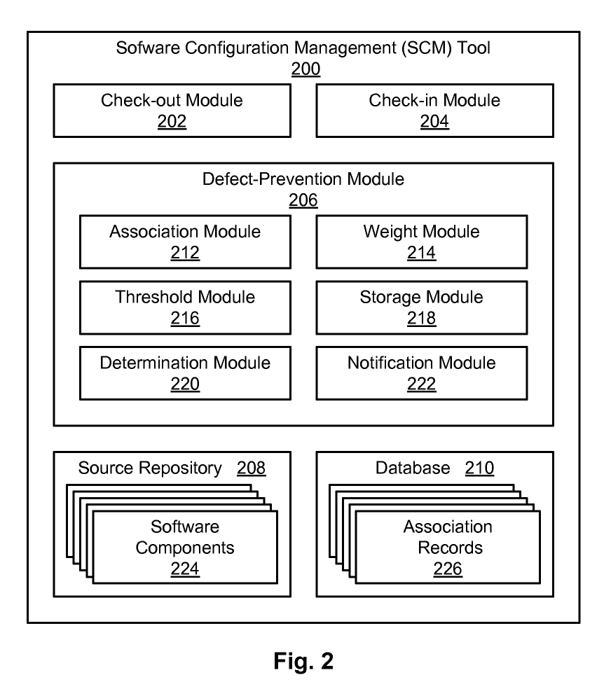

Referring to FIG. 2, as previously mentioned, in large software projects, many different software components may interact to accomplish a goal. To manage and control changes to these software components, a software configuration management (SCM) tool may be used. One example of an SCM tool is IBM's Configuration Management Version Control (CMVC) software package, although the term SCM is used broadly herein to encompass a wide variety of software development tools. Among other features, SCM tools may provide mechanisms for managing different versions of software components, controlling changes to software components, and auditing and reporting changes made to software components. A variety of different SCM tools from different vendors exist, each providing different features and functions. The apparatus and methods discussed herein may be incorporated into a wide variety of different SCM tools and are not limited to any single product.

A high-level view of various internal modules that may be included in an SCM tool 200 are illustrated in FIG. 2. As shown, in one embodiment, the SCM tool 200 includes one or more of a check-out module 202, a check-in module 204, a defect-prevention module 206, a source repository 208, and a database 210. These modules and components are presented only by way of example and are not intended to represent an exhaustive list of modules or components within the SCM tool 200. The SCM tool 200 may include more or fewer modules than those illustrated, or the functionality of the modules may be organized differently.

As shown, the SCM tool 200 may include or interface with a source repository 208 storing one or more software components 224. These software components 224 may include components having different levels of granularity, such as software modules, source files, sections of program code (e.g., functions, etc.), lines of program code, or the like. The software components 224 may also include different types of components, such as code files, XML files, image files, or the like. A check-out module 202 may enable a user to check out software components 224 from the source repository 208 in order to make updates thereto. Similarly, a check-in module 204 may enable the user to check in software components 224 after updates are made, thereby committing the changes to the source repository 208.

As previously mentioned, whenever a software component 224 is changed, there is the possibility of introducing “regression defects” into the software component 224. Regression defects are defects that are introduced into code when fixing, enhancing, or otherwise changing the software components 224. For example, a regression defect may occur when a first software component 224 is updated but a second related software component 224 is not updated to take into account the changes to the first software component 224.

In order to avoid or minimize regression defects, a defect-prevention module 206 may be provided in the SCM tool 200. Alternatively, the defect-prevention module 206 is an external component (i.e., external to the SCM tool 200) that interfaces with the SCM tool 200. In general, the defect-prevention module 206 may be configured to detect changes to software components 224, discover associations between software components 224, and notify a user of related software components 224 that may require updating as a result of changes to certain software components 224. In order to achieve this, the defect-prevention module 206 may include one or more of an association module 212, weight module 214, threshold module 216, storage module 218, determination module 220, and notification module 222, among other modules.

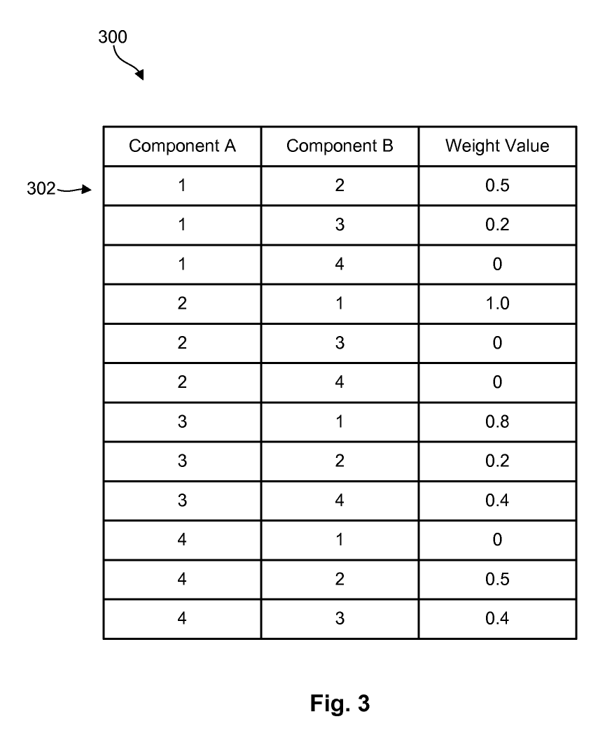

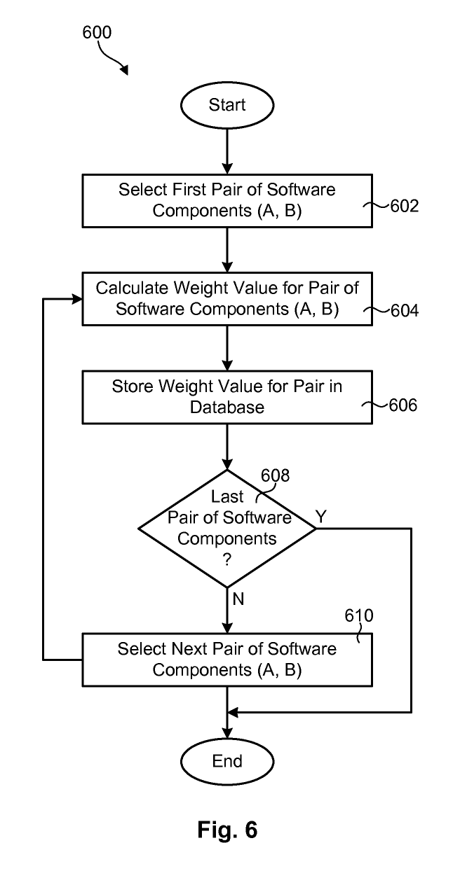

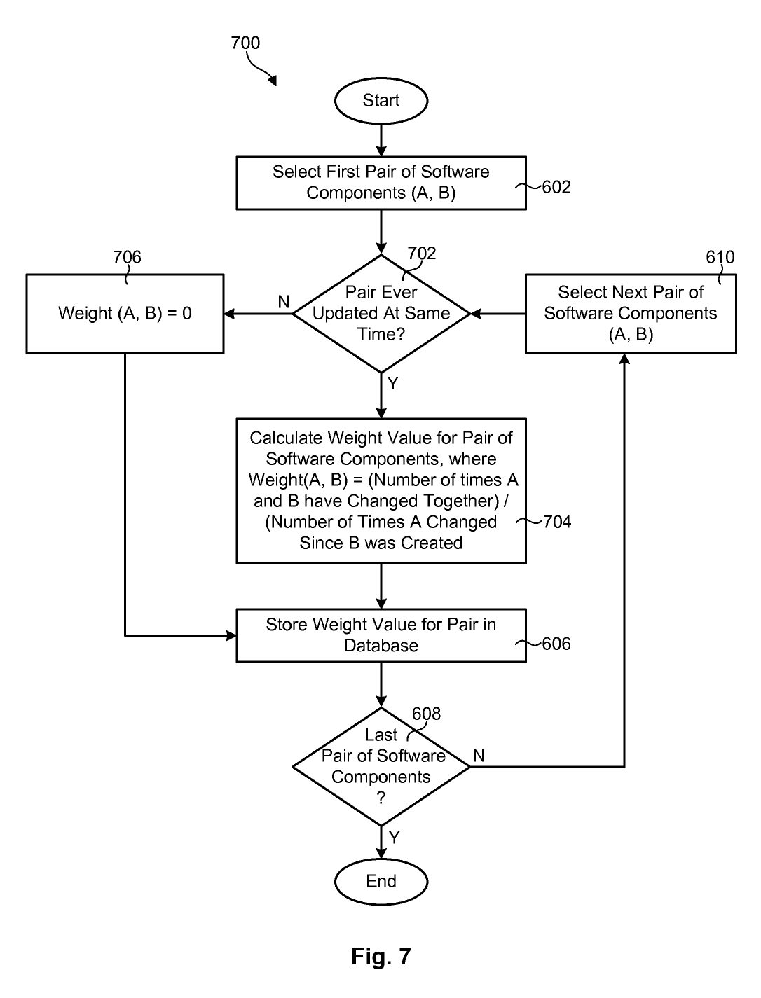

The association module 212 may be configured to determine associations between software components 224 in the source repository 208. Various different techniques may be used to discover these associations. In certain embodiments, the associations may be determined by examining metadata associated with the software components 224, such as metadata describing past operations. For example, associations may be determined by examining the types of committed operations (e.g., create, update, delete, etc.) performed on the software components 224, the timestamps of committed operations performed on the software components 224, or any other metadata describing the software components 224. Alternatively, the association module 212 may enable a user to manually establish associations between selected software components 224. Several examples of methods for establishing associations between software components 224 are described in FIGS. 6 and 7. Once an association is established, a storage module 218 may store a corresponding association record 226 in the database 210. One method for storing association records 226 is described in FIG. 3.

When discovering associations, it should be recognized that not all associations are necessarily equal. For example, some software components 224 may be strongly associated with one another, such that an update to one almost always requires an update to the other. Others may be weakly associated, such that an update to one only sometimes or infrequently requires an update to the other. Some associations may be so weak that they do not raise concern or warrant notifying a user. Thus, techniques are needed to determine the strength of associations between software components 224.

In certain embodiments, a weight module 214 may be provided to determine the strength of associations between software components 224. When the association module 212 discovers an association between two software components 224, the weight module 214 may calculate a weight value reflecting the strength of the association. Alternatively, the weight module 214 may enable a user to manually establish a weight value for the association. In certain embodiments, a weight value of zero may indicate no association whereas a weight value of one may indicate a very strong association. The weight values for the associations may be stored in the association records 226 previously described. Several different techniques for calculating weight values will be discussed in association with FIGS. 6 and 7.

Because not all associations are equal, techniques are needed to filter out weaker associations. In certain embodiments, a threshold module 216 may be configured to establish a threshold weight value. If a user attempts to update a software component 224 which is associated with another software component 224, the user will only be notified if the strength of the association meets the threshold weight value. Thus, if the threshold weight value is 0.7 and the weight value for an association is 0.5, the associated software component 224 would not be presented to the user as a potential omission.

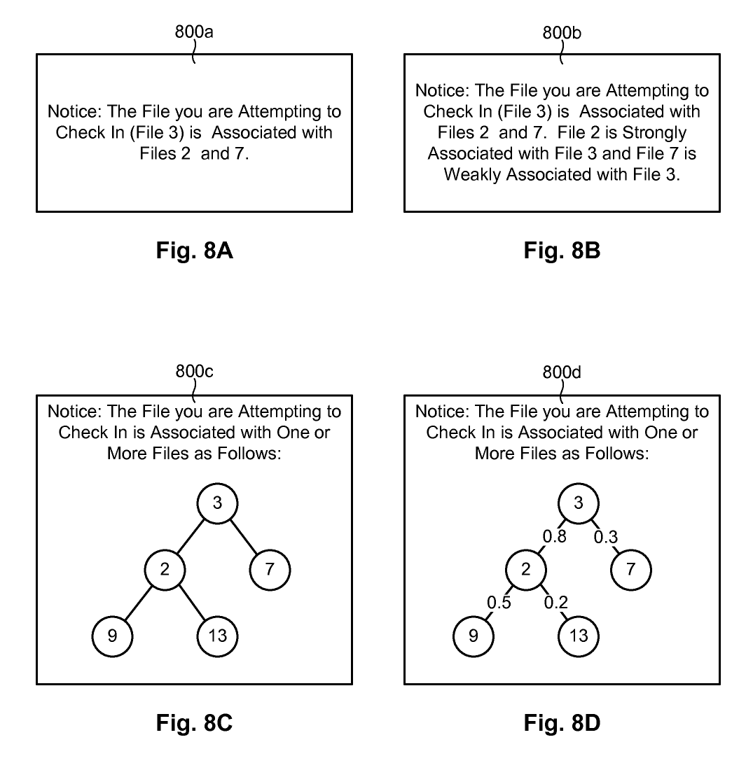

At a designated time, such as when a software component 224 is checked in or out, a determination module 220 checks the database 210 to determine whether any software components 224 are associated with the software component 224 being checked in or out. In certain embodiments, the determination module 220 only looks for associations having a weight value greater than or equal to the established threshold weight value. If an associated software component 224 is found, a notification module 222 notifies the user that one or more related software components 224 have been discovered. This notification may identify the related software components 224. This will allow the user to update the identified software components 224 if needed. The manner in which the notification module 222 may notify the user may vary. Several different examples of notifications are described in association with FIGS. 8A through 8D.

Referring to FIG. 3, as previously mentioned, the defect-prevention module 206 may record associations in association records 226. FIG. 3 provides an example of a table 300 storing association records 226. In this example, each row 302 of the table 300 represents an association record 226. Each time an association is discovered, a row may be added or populated in the table 300. As shown in FIG. 3, each row 302 identifies a pair of software components 224 { A, B} in the source repository 208 and a weight value associated with the pair.

Assume for the sake of example that the source repository 208 contains four software components 224 {1, 2, 3, 4}. The table 300 may include a row for each pair of software components 224. Each row 302 also stores a weight value for the pair to indicate the strength of the association. In this example, a weight value of one represents the strongest association and a weight value of zero indicates no association. Note that the weight value for the pair { A, B} may be different than the weight value for the pair {B, A}. This is because a first software component 224 may always or frequently need to be updated when a second software component 224 is updated, whereas the second software component 224 may not always need to be updated when the first software component 224 is updated. Thus, the weight values for {A, B} may be different than those for {B, A}. In certain embodiments, association records 226 with a weight value of zero may be omitted from the database 210. In other embodiments, association records 226 with a weight value below a selected threshold weight value may be omitted from the database 210.

The table 300 illustrated in FIG. 3 represents just one way of storing associations between software components 224 and is not intended to be limiting. Other techniques or data structures for recording associations are possible and within the scope of the invention.

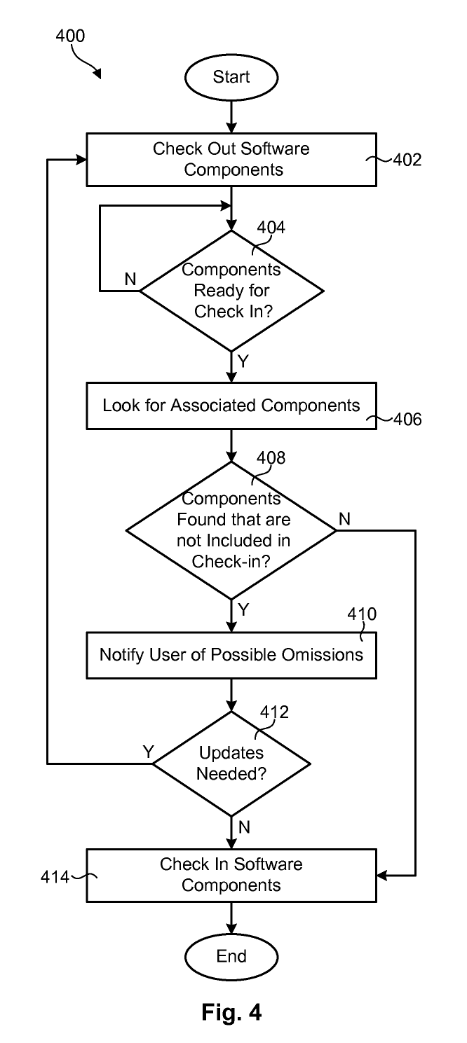

Referring to FIG. 4, one embodiment of a method 400 for preventing regression defects is illustrated. Such a method 400 may implemented within the SCM tool 200 previously described. As shown, the method 400 initially checks out 402 one or more software components 224 to a user, thereby allowing the user to make updates to the software components 224. The method 400 proceeds to determine 404 whether the updated software components 224 are ready for check in. If the software components 224 are ready for check in, the method 400 looks 406 for associated software components 224 in the database 210. If, at step 408, the method 400 finds one or more associated software components 224 that are not being checked in with the updated software components 224, the method 400 notifies 410 the user of the possible omissions. The user may then decide whether the omitted software components 224 need to be updated.

If, at step 412, the user decides that the omitted software components 224 need to be updated, the method 400 returns to step 402 to check out the omitted software components 224 to the user. The method 400 then repeats in the manner previously described for the newly checked-out software components 224. Once a user determines that no further updates are needed, the method 400 allows the user to check in 414 the updated software components 224. In this way, associated software components 224 may be checked in together with the appropriate updates.

One benefit of the method 400 illustrated in FIG. 4 is that it allows a tree of associations to be traversed until no further updates are needed. For example, if a user attempts to check in source file A, where source file A is associated with source file B, and source file B is associated with source file C, the method 400 will initially discover source file B. Upon making the appropriate updates to source file B and attempting to check in source file B, the method 400 will discover source file C. In this way, the method 400 traverses the association tree until no further updates are needed.

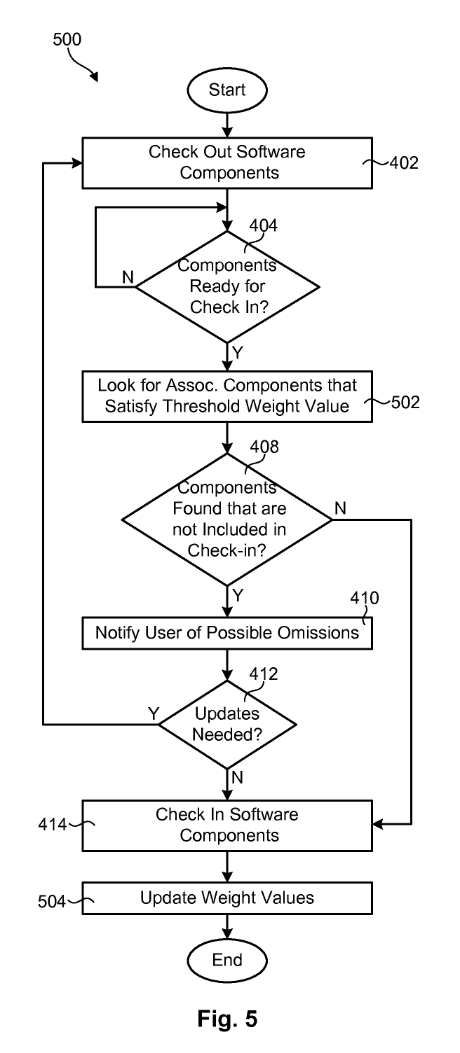

Referring to FIG. 5, as mentioned above, in certain embodiments, the strength of associations may be taken into account when notifying a user of possible omissions. The method 500 illustrated in FIG. 5 is similar to that illustrated in FIG. 4 except that that method 500 considers the weight values of associations. As shown, once the method 500 determines 404 that one or more checked-out software components 224 are ready for check in, the method 500 looks 502 for associated software components 224 that satisfy a threshold weight value. If, at step 408, the method 500 finds one or more software components 224 that satisfy the threshold weight value, the method 500 notifies the user of the possible omissions.

Once the user has finished updating software components 224, the method 500 allows the user to check in 414 the updated software components 224. At this point, the method 500 may update 504 the weight values of relevant associations to reflect their current state (i.e., updating software components 224 may strengthen or weaken associations). A user's decision to update or not update a software component 224 after notice is received may also factor into the weight value.

Referring to FIG. 6, one embodiment of a method 600 for determining associations between software components 224 in a source repository 208 is illustrated. In this example, an association and corresponding weight value is determined for each pair of software components 224 in the source repository 208. As shown, the method 600 initially selects 602 the first pair of software components 224 {A, B} in the source repository 208. The method 600 then calculates 604 a weight value for the pair of software components 224. The weight value for the pair may then be stored 606 in the database 210 as previously discussed. If the weight value for the pair is zero or below a selected threshold, the association record 226 for the pair may be omitted from the database 210. Alternatively, an association record 226 for the pair may be stored in the database 210 regardless of the weight value.

The method 600 then determines 608 whether the pair is the last pair of software components 224 in the source repository 208. If not, the method 600 selects 610 the next pair of software components 224 and repeats the steps 604, 606 in the manner previously described. This continues until each pair of software components 224 is analyzed. In certain embodiments, each pair of software components 224 is analyzed twice—once for {A, B} and again for {B, A}—since the weight values for each may be different.

Referring to FIG. 7, a more particular example of a method 700 for determining associations and corresponding weight values is illustrated. Like the previous example, the method 700 initially selects 602 the first pair of software components 224 {A, B} in the source repository 208. The method 700 then determines 702 if the pair of software components 224 have ever been updated together at the same time. This may be determined by analyzing timestamps or other metadata in the source repository 208. If the pair of software components 224 has never been updated at the same time, then the weight value for the pair is zero, as shown at step 706. This indicates that there is no association or a very weak association between the software components 224.

If, on the other hand, the pair of software components 224 have been updated at least once at substantially the same time, the method 700 calculates 704 a weight value for the pair of software components 224. In this example, the weight value for the pair of software components 224 { A, B } is calculated by finding the number of times that A and B have been updated together, and dividing this number by the number of times A has been updated since B was created. Thus if A and B were created at the same time and B changed four out of the five times that A changed, the weight value would be (4/5), or 0.8. The weight value for the pair may then be stored 606 in the database 210 as previously discussed. The method 700 then determines 608 whether the pair is the last pair of software components 224 in the source repository 208. If not, the method 700 selects 610 the next pair of software components 224 and repeats the steps 604, 606 until each pair of software components 224 has been analyzed. Like the previous example, each pair of software components 224 may be analyzed twice since the weight values for {A, B} and {B, A} may be different.

Referring to FIGS. 8A through 8D, as previously mentioned, when trying to check in or check out a software component 224, the user may be notified of any potential omissions. Such a notification 800 may take many different forms. FIGS. 8A through 8D show various non-limiting examples of notifications 800a-d. FIG. 8A shows one example of a notification 800a that informs a user that the software component 224 he or she is attempting to check in is associated with one or more other software components 224. The notification 800a identifies the associated software components 224 so that appropriate updates can be made. FIG. 8B shows one embodiment of a notification 800b which not only identifies software components 224 associated with the software component 224 being checked in, but also informs the user of the strength of the associations.

The notification 800c of FIG. 8C identifies and displays associated software components 224 in a tree structure. This may be helpful to see not only software components 224 associated with those currently being checked in, but also associations further down the tree structure. This may allow a user to make updates to software components 224 further down the tree structure, if needed. FIG. 8D shows a notification 800d that, in addition to showing a tree structure, shows weight values for associations in the tree structure. In this example, the weight values are displayed on the branches between the software components 224. This will allow the user to consider the weight values when deciding which software components 224 need to be updated.

The flowcharts and block diagrams in the Figures illustrate the architecture, functionality, and operation of possible implementations of systems, methods, and computer-usable media according to various embodiments of the present invention. In this regard, each block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions.

1. A method for preventing regression defects when updating software components, the method comprising:
providing a source repository storing a plurality of software components;
determining associations between software components in the source repository;
storing the associations in a database;
enabling a user to check out a software component from the source repository to make updates thereto;
enabling the user to check in the software component to the source repository after updates are made;
automatically checking the database to determine whether the software component has an association with any other software component in the source repository; and
notifying the user in the event at least one association is discovered in the database.

2. The method of claim 1, wherein automatically checking comprises automatically checking at the time the software component is checked in.

3. The method of claim 1, wherein automatically checking comprises automatically checking at the time the software component is checked out.

4. The method of claim 1, further comprising storing a weight value for each association in the database.

5. The method of claim 4, wherein notifying the user comprises notifying the user if at least one association has a weight value greater than or equal to a threshold weight value.

6. The method of claim 1, wherein notifying the user comprises identifying software components tied to the at least one association.

7. The method of claim 1, wherein the software components comprise at least one of source files, software modules, and code segments.

8. The method of claim 1, wherein determining the associations comprises manually determining the associations.

9. The method of claim 1, wherein determining the associations comprises automatically determining the associations.

10. A computer program product for preventing regression defects when updating software components, the computer program product comprising a computer-usable storage medium having computer-usable program code embodied therein, the computer-usable program code comprising:
computer-usable program code to access a source repository storing a plurality of software components;
computer-usable program code to determine associations between software components in the source repository and store the associations in a database;
computer-usable program code to enable a user to check out a software component from the source repository to make updates thereto;
computer-usable program code to enable the user to check in the software component to the source repository after updates are made;
computer-usable program code to automatically check the database to determine whether the software component has an association with any other software component in the source repository; and
computer-usable program code to notify the user in the event at least one association is discovered in the database.

11. The computer program product of claim 10, wherein automatically checking comprises automatically checking at the time the software component is checked in.

12. The computer program product of claim 10, wherein automatically checking comprises automatically checking at the time the software component is checked out.

13. The computer program product of claim 10, further comprising computer-usable program code to store a weight value for each association in the database.

14. The computer program product of claim 13, wherein notifying the user comprises notifying the user if at least one association has a weight value greater than or equal to a threshold weight value.

15. The computer program product of claim 10, wherein notifying the user comprises identifying the software components tied to the at least one association.

16. The computer program product of claim 10, wherein the software components comprise at least one of source files, software modules, and code segments.

17. An apparatus for preventing regression defects when updating software components, the apparatus comprising:
a source repository storing a plurality of software components;
an association module to determine associations between software components in the source repository;
a storage module to store the associations in a database;
a check-out module to enable a user to check out a software component from the source repository to make updates thereto;
a check-in module to enable the user to check in the software component to the source repository after updates are made;
a determination module to automatically check the database to determine whether the software component has an association with any other software component in the source repository; and
a notification module to notify the user in the event at least one association is discovered in the database.

18. The apparatus of claim 17, further comprising a weight module to store a weight value for each association in the database.

19. The apparatus of claim 18, further comprising a threshold module to establish a threshold weight value.

20. The apparatus of claim 19, wherein the notification module is configured to notify the user if at least one association has a weight value greater than or equal to the threshold weight value.
